(19) United States
(12) Patent Application Publication
(10) Pub. No.: US 2025/0064069 A1
(43) Pub. Date: Feb. 27, 2025

(54) Meat Tenderizer with Adjustable Spacing

(71) Applicant: Yong'an Shao, Beijing (CN)

(72) Inventor: Yong'an Shao, Beijing (CN)

(21) Appl. No.: 18/239,411

(22) Filed: Aug. 29, 2023

(30) Foreign Application Priority Data
Aug. 24, 2023 (CN) 2023222897396

(51) Int. Cl. A22C 9/00

(52) U.S. Cl. CPC A22C 9/004; G06T 7/00

(57) ABSTRACT

The utility model discloses a meat tenderizer with adjustable spacing, which relates to the field of meat processing technology. The meat tenderizer with adjustable spacing comprises a fixing frame, an installation chamber, a driving tendon cutting roller, a driven tendon cutting roller and a driving mechanism, wherein, the installation chamber is arranged in the fixing frame, the driving tendon cutting roller and the driven tendon cutting roller are rotatably assembled in the installation chamber, and the driving mechanism is arranged on the fixing frame to drive the driving tendon cutting roller and the driven tendon cutting roller to rotate. The utility model is characterized in that both sides of the fixing frame are symmetrically equipped with adjustment holes for the driven tendon cutting roller to pass through at both ends. The meat tenderizer also comprises a push frame arranged in the installation chamber for pushing the driven tendon cutting roller to move along the adjustment holes, and an operating component for pushing the push frame, with one end located on the side of the push frame away from the driven tendon cutting roller and the other end passing through the fixing frame. The above technical solution has the advantage of adjusting the gap distance between the driving and driven tendon cutting rollers, so that the meat tenderizer can adapt to different thicknesses of meat pieces, without the need to cut the meat pieces into the same thickness to cut the tendons and tenderize the meat pieces.

### CROSS REFERENCE TO RELATED APPLICATION

This application claims priority to Chinese Patent Application Number 2023222897396, filed Aug. 24, 2023.

### FIELD OF THE INVENTION

The utility model relates to the technical field of meat processing, in particular to a meat tenderizer with adjustable spacing.

### BACKGROUND OF THE INVENTION

Meat tenderizing is required when processing meat food. The muscle fiber tissue of meat pieces is destroyed, thereby tenderizing the meat. The usual working process of the meat tenderizing equipment currently used for meat tenderizing (such as a beef tenderier disclosed by CN208956839U) is as follows: the meat pieces of specific thickness are placed between the two tenderizing rollers of the tenderizer, and after the tenderizer is in operation, the meat pieces are tenderized by cutting the tendons. When using this meat tenderizer to cut the tendons of meat pieces, the distance between the two breaking rollers cannot be adjusted. Therefore, the meat tenderizer can only cut the tendons of meat pieces of specific thickness. At the same time, when in use, it needs to cut the meat pieces into a consistent thickness before tenderizing, which is troublesome to use.

### DETAILED DESCRIPTION

The utility model aims to provide a meat tenderizer with adjustable spacing to solve the defects of the current art, which has the advantage of adjusting the gap distance between the driving and driven tendon cutting rollers, so that the meat tenderizer can adapt to different thicknesses of meat pieces, without the need to cut the meat pieces into the same thickness to cut the tendons and tenderize the meat pieces

To achieve the above purpose, the utility model adopts the following technical solution: a meat tenderizer with adjustable spacing comprises a fixing frame, an installation chamber, a driving tendon cutting roller, a driven tendon cutting roller and a driving mechanism, wherein, the installation chamber is arranged in the fixing frame, the driving tendon cutting roller and the driven tendon cutting roller are rotatably assembled in the installation chamber, and the driving mechanism is arranged on the fixing frame to drive the driving tendon cutting roller and the driven tendon cutting roller to rotate. The utility model is characterized in that both sides of the fixing frame are symmetrically equipped with adjustment holes for the driven tendon cutting roller to pass through at both ends. The meat tenderizer also comprises a push frame arranged in the installation chamber for pushing the driven tendon cutting roller to move along the adjustment holes, and an operating component for pushing the push frame, with one end located on the side of the push frame away from the driven tendon cutting roller and the other end passing through the fixing frame.

The operating component comprises a limit part, an inserting piece and an operating rod, wherein, the limit part is arranged on the outer side wall of the fixed frame and provided with movable holes, the inserting piece is fixedly arranged on the push frame and inserted in the movable holes, one end of the operating rod is arranged in the inserting piece, and the other end passes through the movable holes and is placed outside the limit part.

The movable holes include a first thread hole away from one side of the fixing frame, and an inserting hole close to one side of the fixing frame and with the diameter larger than that of the first thread hole. The inserting piece is provided with a first rotating hole inside and a second rotating hole located on the side with the first rotating hole and with the diameter smaller than that of the first rotating hole. The operating rod comprises a screw part that is sequentially threaded through the first thread hole at one end and engaged with the second rotating hole, a limit plate part that is integrally arranged at one end of the screw part and located within the first rotating hole and can rotate relative to the inserting piece under the drive of the screw part, and an operating part fixed at one end of the screw part away from the limit plate part.

Two guide grooves are arranged on the inner side wall of the installation chamber of the fixing frame and located at both ends of the driven tendon cutting roller, and the two sides of the push frame are slidably assembled in the guide grooves, and the adjustment holes run through the guide grooves.

The adjustment holes are in a circular arc shape. The driving mechanism comprises a motor arranged on the fixing frame, and a transmission gear assembly in driving connection with the power output shaft of the motor for driving the driving tendon cutting roller and the driven tendon cutting roller to rotate under the driving of the power output shaft. The transmission gear assembly is connected through at least four gears.

The transmission gear assembly comprises a first gear, a second gear, a third gear and a fourth gear, which are engaged with each other and all located on the outer wall of the fixing frame. The first gear is fixedly connected to the end of the driving tendon cutting roller, the fourth gear is fixedly connected to the end of the driven tendon cutting roller, and the second gear and the third gear are both assembled on the fixing frame through a rotating shaft. The second gear is respectively engaged with the first gear and the third gear, and the third gear is engaged with the fourth gear. The circular adjustment holes are concentric with the third gear.

The motor is arranged on the outer side wall of the fixing frame, and the shaft of the motor is fixedly connected to one end of the driving tendon cutting roller away from the first gear.

The meat tenderizer with adjustable spacing also comprises a fixing mechanism fixed on the fixing frame for fixing the meat tenderizer to an external assembly.

The fixing mechanism comprises a fixing rod fixed on the fixing frame; a first clamping plate part integrally arranged on the fixing rod, away from one end of the fixing frame, and perpendicular to the fixing rod; a second clamping plate part integrally arranged on the fixing rod and provided with a clamping space between the first clamping plate part, and a second thread hole provided on the first clamping plate part for the thread rod to pass through.

The fixing frame is sleeved with a protective cover outside, and openings are set on both of the upper and lower sides of the protective cover.

After adopting the above technical solution, the utility model has the following advantages: a meat tenderizer with adjustable spacing comprises a fixed frame, a driving tendon cutting roller, a driven tendon cutting roller), a driving mechanism, a push frame and an operating component.

An installation chamber is arranged in the fixing frame. The driving and driven tendon cutting rollers are both rotatably assembled in the installation chamber, and the driving mechanism is arranged on the fixing frame to drive the driving and driven tendon cutting rollers to rotate. The driving and driven tendon cutting rollers are arranged in parallel with a gap for meat pieces to enter. Both sides of the fixing frame are symmetrically equipped with adjustment holes for the driven tendon cutting roller to pass through at both ends. A push frame is arranged in the installation chamber for pushing the driven tendon cutting roller to move along the adjustment holes. One end of the operating component is arranged on the side away from the driven tendon cutting roller on the push frame, and the other end passes through the fixing frame. The operating component is used to push the push frame to drive the driven tendon cutting roller to move along the adjustment holes to adjust the gap distance between the driving tendon cutting roller and the driven tendon cutting roller, so that the meat tenderizer can adapt to different thicknesses of meat pieces, without the need to cut the meat pieces into the same thickness to cut tendons and tenderize the meat pieces.

### DESCRIPTION OF THE DRAWINGS

To more clearly explain the technical proposal of the embodiments of the utility model or the prior art, the drawings required for the description of the embodiments or the prior art are briefly introduced. It is obvious that the drawings below are only for some embodiments of the utility model. The ordinary technicians in the field can also obtain other drawings from these drawings without creative labor.

FIG. 1 is the structural diagram of the utility model;

FIG. 2 is the structural diagram of the utility model in another direction;

FIG. 3 is the section view of the utility model;

FIG. 4 is the structural diagram of the utility model with the protective cover;

Drawing markings: 1. fixing frame; 2. driving tendon cutting roller; 3. driven tendon cutting roller; 4. driving mechanism; a. adjustment hole; 5. push frame; 6. operating component; 7. imit part; 8. inserting piece; c. inserting hole; 9. screw part; 10. limit plate part; 11. operation part; e. guide groove; 12. motor; 13. transmission gear components; 14. first gear; 15. second gear; 16. third gear; 17. fourth gear; 18. fixing rod; 19. first clamping plate part; 20. second clamping plate part; f. second thread hole; 23. protective cover.

### DETAILED DESCRIPTION OF THE PREFERRED EMBODIMENTS

The utility model is further described in detail in combination with the drawings.

The embodiments are only the interpretation of the utility model, but not a limitation to the utility model. The techanicans in the field can make modifications without creative contributions to the embodiment as required after reading the specification, and such modifications within the scope of the claims of the utility model are protected by the patent law.

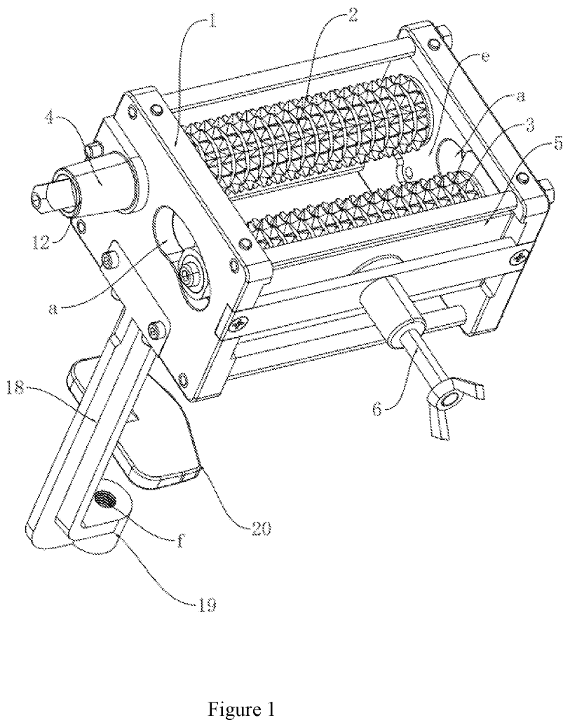

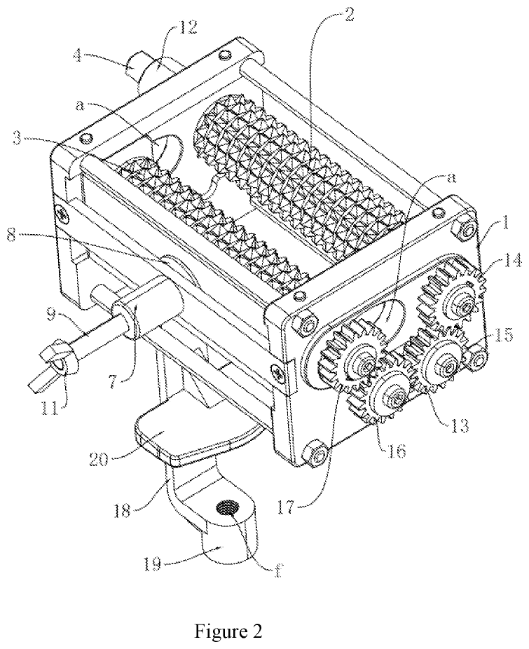

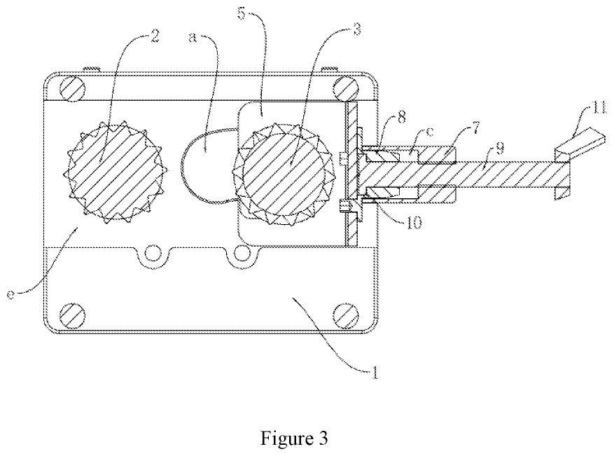

This embodiment relates to a meat tenderizer with adjustable spacing, as shown in FIGS. 1-3, which comprises a fixing frame 1, a driving tendon cutting roller 2, a driven tendon cutting roller 3, a driving mechanism 4, a push frame 5 and an operating component 6.

An installation chamber is arranged in the fixing frame 1. The driving tendon cutting roller 2 and driven tendon cutting roller 3 are both rotatably assembled in the installation chamber, and the driving mechanism 4 is arranged on the fixing frame 1 to drive the driving tendon cutting roller 2 and driven tendon cutting roller 3 to rotate. The driving tendon cutting roller 2 and driven tendon cutting roller 3 are arranged in parallel with a gap for meat pieces to enter. Both sides of the fixing frame 1 are symmetrically equipped with adjustment holes a for the driven tendon cutting roller 3 to pass through at both ends. A push frame 5 is arranged in the installation chamber for pushing the driven tendon cutting roller 3 to move along the adjustment holes a. In this embodiment, the gap between the driving tendon cutting roller 2 and the driven tendon cutting roller 3 on the push frame 5 is an opening, and the push frame 5 is in a [symbol] shape. One end of the operating component 6 is arranged on the push frame 5, away from the side of the driven tendon cutting roller 3, and the other end passes through the fixing frame 1. The operating component 6 is used to push the push frame 5 to drive the driven tendon cutting roller 3 to move along the adjustment holes a to adjust the gap distance between the driving tendon cutting roller 2 and the driven tendon cutting roller 3, so that the meat tenderizer can adapt to different thicknesses of meat pieces without cutting the meat pieces into the same thickness.

Preferably, in order to enable the operating component 6 to drive the push frame 5 to move, thereby driving the driven tendon cutting roller 3 to move in the adjustment holes a, the operating component 6 comprises a limit part 7, a inserting piece 8, and an operating rod. The limit part 7 is arranged on the outer wall of the fixing frame 1, and there are movable holes on the limit part 7. The limit part 7 is integrated with the fixing frame 1, and the inserting piece 8 is fixed on the push frame 5 and can be connected to the movable holes. The inserting piece 8 is fixed to the outer wall of the push frame 5 by screws, and in some embodiments, the inserting piece 8 is welded to the outer wall. One end of the operating rod is arranged inside the inserting piece 8, and the other end passes through the movable hole and placed outside the limit part 7. Optionally, the movable holes include a first thread hole and a second thread hole. The first thread hole is far away from one side of the fixing frame 1, and the insertion hole c is close to one side of the fixing frame 1 and has a diameter greater than the first thread hole. The inserting piece 8 is equipped with a first rotating hole. The side of the inserting piece 8 located on the first rotating hole is provided with a second rotating hole with a diameter smaller than the first rotating hole. The operating rod comprises a screw part 9, a limit plate part 10, and an operating part 11. One end of the screw part 9 sequentially passes through the first thread hole, the insertion hole c, and the second rotating hole, and the screw part 9 is engaged with the first thread hole. The limit plate part 10 is integrally arranged at one end of the screw part 9 and is limited to the first rotating hole. The limit plate part 10 can rotate relative to the inserting piece 8 under the drive of the screw part 9. The operating part 11 is fixedly arranged at one end of the screw part 9 away from the limit plate part 10. In this embodiment, in order to make the push frame 5 move along a specific path, two guide grooves e are set on the inner wall of the installation cavity of the fixing frame 1. The two guide grooves e are located at both ends of the driven tendon cutting roller 3. The two sides of the push frame 5 are slidably assembled in the guide grooves e, and the adjustment holes a run through the guide grooves e, and both ends of the driving tendon cutting roller 2 respectively pass through the two guide grooves e.

Preferably, in order to make the driving mechanism 4 to automatically drive the driving tendon cutting roller 2 and driven tendon cutting roller 3, thereby enabling the meat tenderizer to cut tendon and tenderize the meat pieces, the adjustment holes a are in a circular arc shape, and the driving mechanism 4 comprises the motor 12 and the transmission gear component 13. The motor 12 is installed on the fixing frame 1. The transmission gear assembly 13 is in driving connection with to the power output shaft of the motor 12, which is used to drive the driving tendon cutting roller 2 and the driven tendon cutting roller 3 to rotate under the drive of the power output shaft. The transmission gear assembly 13 is connected through at least four gears for transmission. It should be noted that when there are multiple gears arranged, the multiple gears are symmetrically arranged on the two outer walls of the fixing frame 1. The gears on the two outer walls of the fixing frame 1 can be transmitted through the driving tendon cutting roller 2 and the driven tendon cutting roller 3. In other embodiments, the driving mechanism 4 comprises a motor 12 and a belt transmission component. The motor 12 is installed on the outer wall of the fixing frame 1, and the power output shaft of the motor 12 is in driving connection with the belt transmission component. The belt transmission component comprises a driving belt pulley, a tensioning pulley, a driven belt pulley, and a belt. The driving belt pulley is in driving connection with the driving tendon cutting roller 2, and the driven belt pulley is driven and connected to the driven tendon cutting roller 3. The tensioning pulley can be slidably assembled on the fixing frame 1 through sliding grooves and fixing screws. The belt is sleeved on the driving belt pulley, tensioning pulley and driven belt pulley, and the motor 12 is driven and connected to one end of the driving tendon cutting roller 2 or to the driving belt pulley.

In this embodiment, in order to enable the transmission gear assembly 13 to drive the driving tendon cutting roller 2 and the driven tendon cutting roller 3 under the drive of the motor 12, and to facilitate the adjustment of the spacing between the driving tendon cutting roller 2 and the driven tendon cutting roller 3, the transmission gear assembly 13 comprises the first gear 14, the second gear 15, the third gear 16 and the fourth gear 17. Among them, the first gear 14, the second gear 15, the third gear 16 and the fourth gear 17 are all located on the outer side wall of the fixing frame 1. The first gear 14, the second gear 15, the third gear 16 and the fourth gear 17 are all located on the same side outside the fixing frame 1. The first gear 14 is fixedly connected to the end of the driving tendon cutting roller 2, the fourth gear 17 is fixedly connected to the end of the driven tendon cutting roller 3, the second gear 15 and the third gear 16 are both rotationally assembled on the fixing frame 1 through a rotating shaft, the second gear 15 is respectively engaged with the first gear 14 and the third gear 16, and the third gear 16 is engaged with the fourth gear 17. The circular adjustment holes a are concentric with the third gear 16.

It should be noted that when it is necessary to adjust the spacing between the driving tendon cutting roller 2 and the driven tendon cutting roller 3, the user can rotate the operating part 11 to drive the screw part 9 to move towards the side close to the push frame 5, thereby pushing the push frame 5. Afterwards, the driven tendon cutting roller 3 moves along the adjustment holes a under the driving of the push frame 5, thereby reducing the gap between the driven tendon cutting roller 3 and the driving tendon cutting roller 2. During this process, the third gear 16 is engaged with the fourth gear 17. The user can rotate the operating part 11 in another direction to drive the screw part 9 to move away from the push frame 5, thereby driving the push frame 5 and the driven tendon cutting roller 3 to move away from the driving tendon cutting roller 2, thereby increasing the gap between the driving tendon cutting roller 2 and the driven tendon cutting roller 3.

In other embodiments, the transmission gear assembly 13 comprises a first gear 14, a second gear 15, a third gear 16, a fourth gear 17 and a fifth gear that engaged with each other, wherein the first gear 14, the second gear 15, the third gear 16, the fourth gear 17 and the fifth gear are all located on the same side outside the fixing frame 1. The first gear 14 is fixedly connected to the end of the driving tendon cutting roller 2, the fourth gear 17 is fixedly connected to the end of the driven tendon cutting roller 3, the second gear 15 and the third gear 16 are both rotationally assembled on the fixing frame 1 through a rotating shaft, the second gear 15 is engaged with the first gear 14 and the third gear 16, the third gear 16 is engaged with the fourth gear 17, and the fifth gear can be engaged with any one of the first gear 14, the second gear 15, and the third gear 16. The power output shaft of the motor 12 is in driving connection with the fifth gear. The circular adjustment holes a are concentric with the third gear 16.

Optionally, the motor 12 is arranged on the outer side wall of the fixing frame 1, and the shaft of the motor 12 is fixedly connected to one end of the driving tendon cutting roller 2 away from the first gear 14. In other embodiments, the shaft of the motor 12 is in driving connection with the second gear 15 or the third gear 16.

Optionally, in order to facilitate the fixation between the meat tenderer and external equipment, the meat tenderer also comprises a fixing mechanism fixed on the fixing frame 1 for fixing the meat tenderer to the external assembly. In this embodiment, the fixing mechanism comprises a fixing rod 18, a first clamping plate part 19, a second clamping plate part 20 and a thread rod. The fixing rod 18 is fixedly arranged on the fixing frame 1. The first clamping plate part 19 is integrally arranged on the fixing rod 18 at the end away from the fixing frame 1, and the first clamping plate part 19 is perpendicular to the fixing rod 18. The second clamping plate part 20 is integrally arranged on the fixing rod 18, and a clamping space is provided between the second clamping plate part 20 and the first clamping plate part 19. The first clamping plate part 19 is provided with a second thread hole f for threading the thread rod. The external equipment can be inserted into the clamping space, and the user can fix the meat tenderer on the external equipment by rotating the thread rod which is inserted into the second thread hole f.

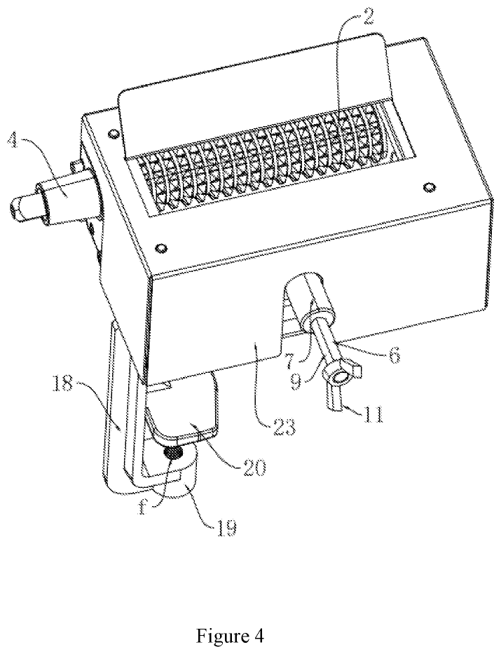

Preferably, as shown in FIG. 4, the protective cover 23 is sleeved outside the fixing frame 1, and can be fixed to the fixing frame 1 by screws. There are openings on both the upper and lower sides of the protective cover 23 to prevent foreign objects from entering the transmission gear assembly 13 without affecting the operation of the meat tenderer, which may affect the transmission of the transmission gear assembly 13 or cause injury when the user's hand comes into contact with the rotating gear during the operation of the meat tenderer.

The above is only used to describe the technical proposal of the utility model and not to limit it, and other modifications or equivalent replacements made by the ordinary technicians in the field to the technical proposal of the utility model should be covered in the scope of claims of the utility model as long as they do not deviate from the spirit and scope of the technical proposal of the utility model.

1. A meat tenderizer with adjustable spacing comprises a fixing frame (1), an installation chamber, a driving tendon cutting roller (2), a driven tendon cutting roller (3) and a driving mechanism (4), wherein, the installation chamber is arranged in the fixing frame (1), the driving tendon cutting roller (2) and the driven tendon cutting roller (3) are rotatably assembled in the installation chamber, and the driving mechanism (4) is arranged on the fixing frame to drive the driving tendon cutting roller (2) and the driven tendon cutting roller (3) to rotate. The utility model is characterized in that both sides of the fixing frame (1) are symmetrically equipped with adjustment holes (a) for the driven tendon cutting roller (3) to pass through at both ends. The meat tenderizer also comprises a push frame (5) arranged in the installation chamber for pushing the driven tendon cutting roller (3) to move along the adjustment holes (1), and an operating component (6) for pushing the push frame (5), with one end located on the side of the push frame (5) away from the driven tendon cutting roller (3) and the other end passing through the fixing frame (1).

2. The meat tenderizer with adjustable spacing according to claim 1 is characterized in that the operating component (6) comprises a limit part (7), an inserting piece (8) and an operating rod, wherein, the limit part (7) is arranged on the outer side wall of the fixing frame (1) and provided with movable holes, the inserting piece (8) is fixedly arranged on the push frame (5) and inserted in the movable holes; one end of the operating rod is arranged in the inserting piece (8), and the other end passes through the movable holes and is placed outside the limit part (7).

3. The meat tenderizer with adjustable spacing according to claim 2 is characterized in that the movable holes include a first thread hole away from one side of the fixing frame (1), and an inserting hole (c) close to one side of the fixing frame (1) and with the diameter larger than that of the first thread hole. The inserting piece (8) is provided with a first rotating hole inside and a second rotating hole located on the side with the first rotating hole and with the diameter smaller than that of the first rotating hole. The operating rod comprises a screw part (9) that is sequentially threaded through the first thread hole at one end and engaged with the second rotating hole, a limit plate part (10) that is integrally arranged at one end of the screw part (9) and located within the first rotating hole and can rotate relative to the inserting piece (8) under the drive of the screw part (9), and an operating part (11) fixed at one end of the screw part (9) away from the limit plate part (10).

4. The meat tenderizer with adjustable spacing according to claim 1 is characterized in that two guide grooves (e) are arranged on the inner side wall of the installation chamber of the fixing frame (1) and located at both ends of the driven tendon cutting roller (3), and the two sides of the push frame (5) are slidably assembled in the guide grooves (e), and the adjustment holes (a) run through the guide grooves (e).

5. The meat tenderizer with adjustable spacing according to claim 1 is characterized in that the adjustment holes (a) are in a circular arc shape. The driving mechanism (4) comprises a motor (12) arranged on the fixing frame (1), and a transmission gear assembly (13) in driving connection with the power output shaft of the motor (12) for driving the driving tendon cutting roller (2) and the driven tendon cutting roller (3) to rotate under the driving of the power output shaft. The transmission gear assembly (13) is connected through at least four gears.

6. The meat tenderizer with adjustable spacing according to claim 5 is characterized in that the transmission gear assembly (13) comprises a first gear (14), a second gear (15), a third gear (16) and a fourth gear (17), which are engaged with each other and all located on the outer wall of the fixing frame (1). The first gear (14) is fixedly connected to the end of the driving tendon cutting roller (2), the fourth gear (17) is fixedly connected to the end of the driven tendon cutting roller (3), and the second gear (15) and the third gear (16) are both assembled on the fixing frame (1) through a rotating shaft. The second gear (15) is respectively engaged with the first gear (14) and the third gear (16), and the third gear (16) is engaged with the fourth gear (17). The circular adjustment holes (a) are concentric with the third gear (16).

7. The meat tenderizer with adjustable spacing according to claim 6 is characterized in that the motor (12) is arranged on the outer side wall of the fixing frame (1), and the shaft of the motor (12) is fixedly connected to one end of the driving tendon cutting roller (2) away from the first gear (14).

8. The meat tenderizer with adjustable spacing according to claim 7 is characterized by also comprising a fixing mechanism fixed on the fixing frame (1) for fixing the meat tenderizer to an external assembly.

9. The meat tenderizer with adjustable spacing according to claim 8 is characterized in that the fixing mechanism comprises a fixing rod (18) fixed on the fixing frame (1); a first clamping plate part (19) integrally arranged on the fixing rod (18), away from one end of the fixing frame (1), and perpendicular to the fixing rod (18); a second clamping plate part (20) integrally arranged on the fixing rod (18) and provided with a clamping space between the first clamping plate part (19), and a second thread hole (f) provided on the first clamping plate part (19) for the thread rod to pass through.

10. The meat tenderizer with adjustable spacing according to claim 7 is characterized in that the fixing frame (1) is sleeved with a protective cover (23) outside, and openings are set on both of the upper and lower sides of the protective cover (23).
